(19) United States
(12) Patent Application Publication
(10) Pub. No.: US 2017/0001871 A1
(43) Pub. Date: Jan. 5, 2017

(54) DEVICE AND METHOD FOR PRODUCING NANO SILICA MATERAILS FROM PYROLYSIS OF BIOMASS

(71) Applicant: ZHONGYING CHANGJIANG INTERNATIONAL NEW ENERGY INVESTMENT CO., LTD., Wuhan (CN)

(72) Inventors: Yilong CHEN, Wuhan (CN); Yanfeng ZHANG, Wuhan (CN); Xu HAN, Wuhan (CN); Hong LI, Wuhan (CN); Leiming TAO, Wuhan (CN)

(21) Appl. No.: 15/203,781

(22) Filed: Jul. 6, 2016

Related U.S. Application Data
(63) Continuation-in-part of application No. PCT/CN2015/071390, filed on Jan. 23, 2015.

(51) Int. Cl. C01B 33/18; C10B 57/00; F22G 1/02; C10B 47/22; C10L 3/00; C10B 53/02; C10B 57/10

(52) U.S. Cl. CPC C01B 33/18; C10B 53/02; C10B 57/005; C10B 57/10; C10B 47/22; C10L 3/00; F22G 1/02; C10L 2290/02; C10L 2290/06

(57) ABSTRACT

A device for speeding up production rate of biomass pyrolysis gas to prepare nanoscale silica materials. The device includes: a screw feeder; a mixer; a pyrolysis device having a cinder hole; a combustion train; a steam generator; and a calcination device. In operation, biomass material is transported to the mixer via the screw feeder. The mixer operates to stir the biomass material, then the biomass material and overheated steam generated by the steam generator are mixed and introduced to the pyrolysis device. The pyrolysis device operates to produce combustible gas, and the combustible gas is combusted in the combustion train. The combustion train produces hot smoke, and the hot smoke heats the steam generator to produce the overheated steam. The cinder hole is disposed at a bottom of the pyrolysis device and operates to discharge cinder, and the cinder is transported to the calcination device to calcine.

### CROSS-REFERENCE TO RELATED APPLICATIONS

This application is a continuation-in-part of International Patent Application No. PCT/CN2015/071390 with an international filing date of Jan. 23, 2015, designating the United States, now pending, and further claims priority benefits to Chinese Patent Application No. 201410004144.4 filed Jan. 6, 2014. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, and Cambridge, Mass. 02142.

### BACKGROUND OF THE INVENTION

Field of the Invention

The invention relates to a device and a method for speeding up production rate of biomass pyrolysis gas to prepare nanoscale silica materials.

Description of the Related Art

Typically, inorganic materials are used to prepare amorphous silica, but the method consumes large amount of energy and causes serious environmental pollution. Methods for producing silica from biomass are also disclosed. However, the utilization rate of the biomass is low, and the water content of the biomass greatly affects the production efficiency of the pyrolysis gas. In addition, the pyrolysis temperature is often low, which leads to tar coagulation on the walls of the transportation pipelines of combustion equipment.

### SUMMARY OF THE INVENTION

In view of the above-described problems, it is one objective of the invention to provide a device and method for speeding up production rate of biomass pyrolysis gas to prepare nanoscale silica materials.

To achieve the above objective, in accordance with one embodiment of the invention, there is provided a device for speeding up production rate of biomass pyrolysis gas to prepare nanoscale silica materials.

The device comprises a screw feeder, a mixer for pretreatment, a pyrolysis device, a combustion train, a steam generator and a calcination device. In operation, biomass material is transported to the mixer via the screw feeder. The mixer operates to stir the biomass material, and then the biomass material and overheated steam generated by the steam generator are mixed and introduced to the pyrolysis device. The pyrolysis device operates to produce combustible gas, and the combustible gas is introduced to and combusted in the combustion train. The combustion train produces hot smoke, and the hot smoke heats the steam generator to produce the overheated steam. A cinder hole is disposed at a bottom of the pyrolysis device to discharge cinder, and the cinder is transported to the calcination device to calcine.

In a class of this embodiment, the steam generator is an electrical steam generator, a fuel-oil steam generator or a fuel-gas steam generator.

In a class of this embodiment, the steam generator is the fuel-oil steam generator.

In a class of this embodiment, the fuel-oil steam generator comprises a chamber, an S-shaped coiler, a water tank and an overheating coiler having two-way fins. The S-shaped coiler, the water tank, and the overheating coiler having two-way fins are arranged from bottom to top in the chamber in that order.

A method for speeding up production rate of biomass pyrolysis gas to prepare nanoscale silica materials comprises: uniformly stirring biomass material; heating and drying the biomass material using overheated steam, where a temperature of the overheated steam ranges between 120° C. and 150° C.; pyrolyzing the biomass material under anaerobic conditions to yield combustible gas, where a pyrolysis temperature ranges between 600° C. and 800° C.; combusting the combustible gas produced by the pyrolysis device to produce hot smoke; and heating a steam generator using the hot smoke to produce the overheated steam; calcining cinder discharged from a cinder hole at a bottom of a pyrolysis device under aerobic conditions to yield amorphous nanoscale silica materials.

In a class of this embodiment, the biomass material is transported to the mixer via the screw feeder. The biomass material is mixed, heated and dried by the overheated steam produced by the steam generator. Then the biomass material is introduced to the pyrolysis device to produce the combustible gas. The combustible gas is allowed to enter a combustion train to burn. The combustion train produces the hot smoke, and the hot smoke operates to heat the overheated steam produced by steam generator. The cinder discharged from the cinder hole is calcined in the calcination device. Then the cinder is cooled and then recycled, and amorphous nanoscale silica materials are obtained.

In a class of this embodiment, the cinder is calcined under air atmosphere at a temperature of between 500° C. and 800° C.

In a class of this embodiment, the combustible gas produced by a pyrolysis is CO, CO₂, H₂, CH₄, C₂H₂, C₂H₄, C₂H₆, C₃H₈, C₃H₁₀, or a mixture thereof.

In a class of this embodiment, the biomass material is rice hull.

Advantages of the device and the method according to embodiments of the invention are summarized as follows:

(1) Overheated steam in the invention operates to pretreat the biomass material, and speed up the pyrolysis of biomass material to produce the combustible gas, so that nanoscale silica materials are yielded. The biomass material is quickly heated and dried by water steam produced by waste heat and then undergo a fast anaerobic pyrolysis at the temperature of between 600° C. and 800° C. The pyrolysis destroys the macromolecular chains such as cellulose, hemicelluloses and lignin, so as to quickly produce pyrolysis gas having high heat value. The pyrolysis gas having high heat value burns and then enters the steam generator. Then the produced water steam is recycled. The residual solid cinder of pyrolysis is calcined under aerobic condition to remove carbonic impurities, and is processed and recycled to yield silica industrial materials with a nanoscale less than 100 nanometers.

(2) The water steam is heated by waste heat of smoke produced by pyrolytic reaction, thus the waste heat of smoke is consumed. In addition, the conventional biomass material (mainly referring to rice hull) have higher water content and consume heat of pyrolysis reactions, resulting in low pyrolysis rate and efficiency, these problems are solved in the invention. Meanwhile, during the pyrolysis of biomass material (mainly referring to rice hull), the tar production is reduced.

(3) The overheated water steam with a temperature of between 120° C. and 150° C. is employed to heat and dry biomass material (mainly referring to rice hull), having a higher drying rate than the conventional method for drying biomass material using hot air at the same temperature. Therefore, the production rate of pyrolysis gas is improved by 20% than the conventional production rate. In addition, the heat value of pyrolysis gas produced in the invention is improved by 10%.

(4) The method of using overheated water steam to dry materials is widely used in chemical, pharmaceutical, food and agricultural and sideline product processing industries, but the method has never been used in the field of biomass energy utilization. When the system is started, the existing drying technique using overheated steam water needs fuel gas or other energies to assist boilers, plasma blowpipes and other equipment so as to ensure a stable operation of the system. However, the steam in the invention is heated by the waste heat of the burnt gas of biomass pyrolysis, and the source of the energy employed to produce steam is different from the conventional technique; the energy utilization efficiency in the invention is also improved and the purpose of the invention is different from that of the conventional waste heat recycling system. Meanwhile, amorphous silica material products are yielded in the invention.

### BRIEF DESCRIPTION OF THE DRAWINGS

FIG. 1 is a structural diagram of a device for speeding up production rate of biomass pyrolysis gas to prepare nanoscale silica materials in accordance with embodiments of the invention;

FIG. 2 is a structural diagram of a steam generator in FIG. 1;

FIG. 3 is an SEM diagram of amorphous nanoscale silica in Example 1; and

FIG. 4 is an XRD diagram of biomass material and amorphous nanoscale silica in Examples 1 and 2.

In the drawings, the following reference numbers are used: 1. Screw feeder; 2. Mixer; 3. Pyrolysis device; 4. Steam generator; 5. Calcination device; 6. Combustion train; 7. S-shaped coiler; 8. Water tank; 9. Overheating coiler having two-way fins; and 10. Chamber.

### DETAILED DESCRIPTION OF THE EMBODIMENTS

For further illustrating the invention, experiments detailing a device and method for speeding up production rate of biomass pyrolysis gas to prepare nanoscale silica materials are described below. It should be noted that the following examples are intended to describe and not to limit the invention.

### Example 1

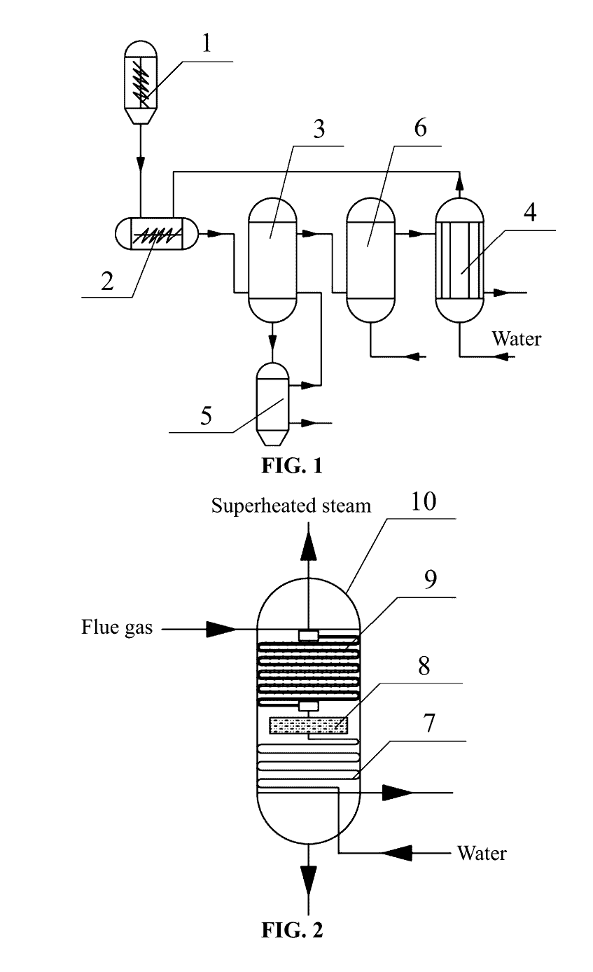

As shown in FIGS. 1-2, a device for speeding up production rate of biomass pyrolysis gas to prepare nanoscale silica materials comprises a screw feeder 1, a mixer for pretreatment 2, a pyrolysis device 3, a combustion train 6, a steam generator 4 and a calcination device 5. Biomass material is transported to the mixer 2 via the screw feeder 1. The biomass material is stirred, then the biomass material and overheated steam generated by the steam generator 4 are mixed and are introduced to the pyrolysis device 3. The pyrolysis device 3 operates to produce combustible gas, and the combustible gas enters the combustion train 6 to burn. The combustion train 6 produces hot smoke, and the hot smoke heats the steam generator 4 to produce the overheated steam. A cinder hole is disposed at a bottom of the pyrolysis device 3 to discharge cinder, and the cinder is transported to the calcination device 5 to calcine. The steam generator 4 can be an electrical steam generator, a fuel-oil steam generator or a fuel-gas steam generator. In the example, the steam generator 4 is the fuel-oil steam generator. The fuel-oil steam generator comprises a chamber 10, an S-shaped coiler 7, a water tank 8 and an overheating coiler having two-way fins 9. The S-shaped coiler 7, the water tank 8 and the overheating coiler having two-way fins 9 are arranged from bottom to top in the chamber 10 in that order.

A method for speeding up production rate of biomass pyrolysis gas to prepare nanoscale silica materials is provided in the example. The method is described as follows.

(1) Rice hull was simply sieved and washed to remove impurities such as dirt in the rice hull. Then the rice hull was transported to the mixer 2 via screw feeder 1 and was dried and heated by mixing with the water steam from a later process.

(2) The mixed materials were transported to the pyrolysis device 3 to perform the pyrolysis at the temperature of 800° C. under anaerobic conditions; the pyrolysis gas was produced quickly, and was transported to the combustion train 6 to release heat.

(3) The waste heat smoke was allowed to enter the steam generator 4 to produce overheated water steam with a temperature of 120° C.; the overheated water steam was introduced back to the mixer 2 to be mixed with the dried biomass material.

The specific steps for producing overheated water steam are as follows: the smoke produced by pyrolysis gas combustion was allowed to enter the steam generator 4; the cold water passed through the S-shaped coiler 7, the water tank 8 and the overheating coiler having two-way fins 9 from bottom to top to be heated, and overheated water steam was yielded.

(4) The solid cinder produced by pyrolysis was transported to the calcination device 5 to calcine at the temperature of 800° C. under aerobic conditions. The calcined solid product was rice hull ash which was grinded to yield silica industrial materials with nanoscale less than 100 nanometers.

The pyrolysis gas was tested by a gas analysis meter. According to the test results, the pyrolysis gas was CO, CO₂, H₂, CH₄, C₂H₂, C₂H₄, C₂H₆, C₃H₈ or C₃H₁₀, or a mixture thereof.

A thermogravimetric analyzer was used online at the pyrolysis device to draw the weight-loss curve of the dried biomass material, and the production rate of pyrolysis gas was concluded. Meanwhile, a gas analyzer was employed to test the heat value of the produced pyrolysis gas in real-time. The production rate of pyrolysis gas in the example was 20% higher than the production rate of pyrolysis gas by conventional method; and the heat value of pyrolysis gas produced in the example was improved by 10%, compared with conventional regular pyrolysis method.

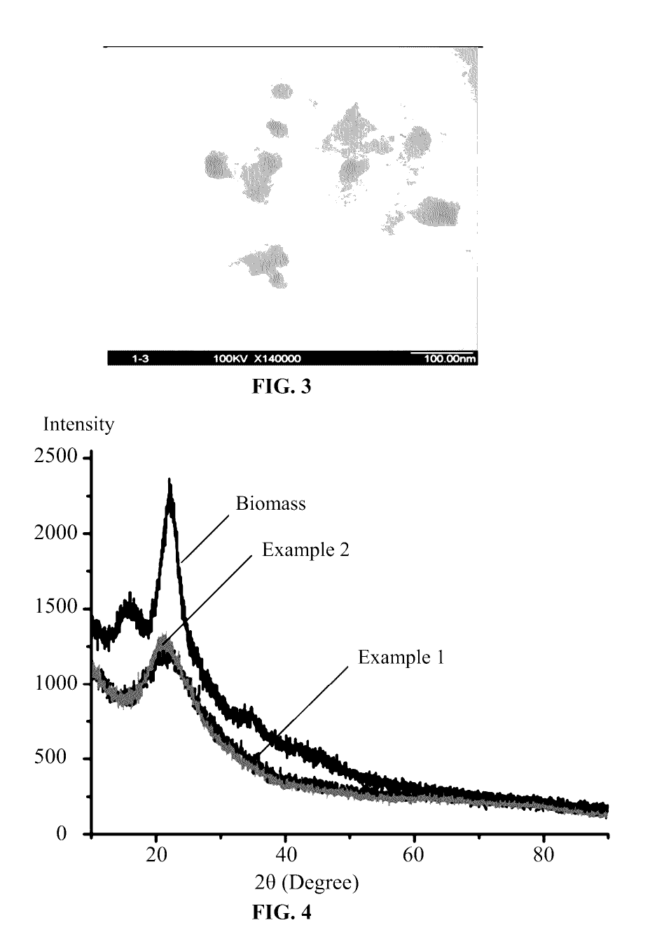

The amorphous nanoscale silica yielded in the example underwent scanning electron microscope and XRD tests, as shown in FIGS. 3-4, respectively. Thus the silica materials were spherical particles with an average particle size less than 100 nm and the particles were loose; and, according to the XRD spectrum, no obvious or specific crystal diffraction peak was shown, thus the product silica was amorphous in structure.

### Example 2

A method for speeding up production rate of biomass pyrolysis gas to prepare nanoscale silica materials is provided in the example. The method comprises the following steps:

(1) Rice hull was simply sieved and washed to remove impurities such as dirt in the rice hull. Then the rice hull was transported to the mixer 2 via screw feeder 1 and was dried and heated by mixing with the water steam from a later process.

(2) The mixed materials were transported to the pyrolysis device 3 to perform the pyrolysis at the temperature of 600° C. under anaerobic conditions; the pyrolysis gas was produced quickly, and was transported to the combustion train 6 to release heat.

(3) The waste heat smoke was allowed to enter the steam generator 4 to produce overheated water steam with a temperature of 150° C. The overheated water steam was introduced back to the mixer 2 to be mixed with the dried biomass material.

(4) The solid cinder produced by pyrolysis was transported to the calcination device 5 to calcine at the temperature of 500° C. under aerobic conditions. The calcined solid product was rice hull ash which was grinded to yield silica industrial materials with nanoscale less than 100 nanometers.

The pyrolysis gas was tested by a gas analysis meter. According to the test results, the pyrolysis gas was CO, CO₂, H₂, CH₄, C₂H₂, C₂H₄, C₂H₆, C₃H₈ or C₃H₁₀, or a mixture thereof.

The amorphous nanoscale silica yielded in the example underwent scanning electron microscope and XRD tests, as shown in FIG. 4, respectively. Thus the silica materials were spherical particles with an average particle size less than 100 nm and the particles were loose; and, according to the XRD spectrum, no obvious or specific crystal diffraction peak was shown, thus the product silica was amorphous in structure.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A device for speeding up production rate of biomass pyrolysis gas to prepare nanoscale silica materials, the device comprising:
a screw feeder;
a mixer for pretreatment;
a pyrolysis device comprising a cinder hole;
a combustion train;
a steam generator; and
a calcination device;
wherein in use,
biomass material is transported to the mixer via the screw feeder; the mixer operates to stir the biomass material, then the biomass material and overheated steam generated by the steam generator are mixed and introduced to the pyrolysis device;
the pyrolysis device operates to produce combustible gas, and the combustible gas is introduced to and combusted in the combustion train;
the combustion train produces hot smoke, and the hot smoke heats the steam generator to produce the overheated steam; and
the cinder hole is disposed at a bottom of the pyrolysis device and operates to discharge cinder, and the cinder is transported to the calcination device to calcine to yield nanoscale silica material.

2. The device of claim 1, wherein the steam generator is an electrical steam generator, a fuel-oil steam generator, or a fuel-gas steam generator.

3. The device of claim 2, wherein the steam generator is the fuel-oil steam generator.

4. The device of claim 3, wherein the fuel-oil steam generator comprises a chamber, an S-shaped coiler, a water tank, and an overheating coiler having two-way fins; the S-shaped coiler, the water tank, and the overheating coiler having two-way fins are arranged from bottom to top in the chamber in that order.

5. A method for speeding up production rate of biomass pyrolysis gas to prepare nanoscale silica materials, the method comprising:
uniformly stirring biomass material;
heating and drying the biomass material using overheated steam, wherein a temperature of the overheated steam ranges between 120° C. and 150° C.;
pyrolyzing the biomass material under anaerobic conditions to yield combustible gas, wherein a pyrolysis temperature ranges between 600° C. and 800° C.;
burning the combustible gas produced by the pyrolysis device to produce hot smoke;
heating a steam generator using the hot smoke to produce the overheated steam; and
calcining cinder discharged from a cinder hole at a bottom of a pyrolysis device under aerobic conditions to yield amorphous nanoscale silica materials.

6. The method of claim 5, wherein the biomass material is transported to a mixer for pretreatment via a screw feeder; the biomass material is, mixed, heated and dried by the overheated steam produced by the steam generator; then the biomass material is introduced to the pyrolysis device and pyrolyzed to produce the combustible gas; the combustible gas is combusted in a combustion train to produce the hot smoke; the hot smoke operates to heat the steam generator to produce the overheated steam; the cinder discharged from the cinder hole is calcined in the calcination device; then the cinder is cooled and then recycled, and amorphous nanoscale silica materials are obtained.

7. The method of claim 5, wherein the cinder is calcined under air atmosphere at a temperature of between 500° C. and 800° C.

8. The method of claim 6, wherein the cinder is calcined under air atmosphere at a temperature of between 500° C. and 800° C.

9. The method of claim 5, wherein the combustible gas produced by the pyrolysis device is CO, CO₂, H₂, CH₄, C₂H₂, C₂H₄, C₂H₆, C₃H₈, C₃H₁₀, or a mixture thereof.

10. The method of claim 6, wherein the combustible gas produced by the pyrolysis device is CO, CO₂, H₂, CH₄, C₂H₂, C₂H₄, C₂H₆, C₃H₈, C₃H₁₀, or a mixture thereof.

11. The method of claim 5, wherein the biomass material is rice hull.

12. The method of claim 6, wherein the biomass material is rice hull.
